(19) United States
(12) Patent Application Publication
(10) Pub. No.: US 2020/0107292 A1
(43) Pub. Date: Apr. 2, 2020

(54) VEHICLE AND METHOD OF CONTROLLING SAME

(71) Applicants: HYUNDAI MOTOR COMPANY, Seoul (KR); KIA MOTORS CORPORATION, Seoul (KR)

(72) Inventors: Dongsoo SHIN, Suwon-si (KR); Jeong-Eom LEE, Yongin-si (KR); Seona KIM, Seoul (KR)

(21) Appl. No.: 16/212,535

(22) Filed: Dec. 6, 2018

(30) Foreign Application Priority Data
Oct. 1, 2018 (KR) 10-2018-0117216

(51) Int. Cl. H04W 68/00; H04W 4/14; H04W 4/40; B60R 11/02; G06F 17/27; G06Q 10/10

(52) U.S. Cl. CPC H04W 68/005; H04W 4/14; G06Q 10/1093; B60R 11/0217; G06F 17/2705; H04W 4/40

(57) ABSTRACT

A vehicle may include: a receiver configured to receive a text message from an outside; an output device configured to output a notification about the text message and the reception of the text message; and a controller to determine a grade of the text message transmitted from the receiver and control the output device based on the determined grade.

### CROSS-REFERENCE TO RELATED APPLICATION

This application is based on and claims the benefit of priority to Korean Patent Application No. 10-2018-0117216, filed on Oct. 1, 2018 in the Korean Intellectual Property Office, the disclosure of which is incorporated herein by reference.

### TECHNICAL FIELD

Embodiments of the present disclosure relate to a vehicle for processing a received text message and a method of controlling the same.

### BACKGROUND

A vehicle is provided with various devices for the convenience of a driver or an occupant (hereinafter referred to as “user”). Further, the vehicle provides the user with various interfaces or services by using the devices.

For example, the vehicle receives text messages from external devices including a user terminal and provides a service configured to notify the user of the text messages.

The service in the related art collectively processes a reception situation acoustically or visually regardless of a traveling state of the vehicle. When the vehicle is traveling, indistinctive notifications of received text messages distract the user's attention and infringe privacy.

### SUMMARY

Therefore, it is an aspect of the present disclosure to provide a vehicle and a method of controlling the same, in which a grade required for a transfer to a user is classified by analyzing a received text message, such that a driver's attention is prevented from being distracted, and privacy is protected.

Additional aspects of the disclosure will be set forth in part in the description which follows and, in part, will be obvious from the description, or may be learned by practice of the disclosure.

In accordance with one aspect of the present disclosure, the vehicle includes: a receiver configured to receive a text message from an outside; an output device configured to output a notification about the text message and the reception of the text message; and a controller configured to determine a grade of the text message transferred from the receiver, and control the output device based on the determined grade.

The controller may extract a keyword included in the text message and determine the grade of the text message based on the extracted keyword.

The controller may select a device included in the output device based on at least one of a pre-stored user schedule, an address book, a relationship with an occupant, or the determined grade of the text message.

The device may include at least one of an audio video navigation (AVN), a hands-free device, or a speaker.

The controller may determine a timing for outputting the text message based on the determined grade of the text message, and may control the output device based on the determined timing.

The controller may determine the grade of the text message by comparing the extracted keyword with the user schedule.

The controller may determine the grade of the text message by comparing a sender number of the text message with the address book.

The output device may output the text message based on the determined timing and a traveling state of the vehicle.

The vehicle may further include a storage configured to store at least one of the user schedule, the address book, a morpheme determination model, or an output policy.

In accordance with another aspect of the present disclosure, a method of controlling the vehicle includes: receiving a text message from an outside; determining a grade of the received text message; and outputting a notification about the text message or a reception of the text message based on the determined grade of the text message.

The determining may include extracting a keyword included in the text message, and determining the grade of the text message based on the extracted keyword;

The outputting may include selecting an output device included in the vehicle based on at least one of a user schedule, an address book, a relationship with an occupant, or the determined grade of the text message which are stored in advance.

The device may include an AVN, a hands-free device, and a speaker which are provided in the vehicle.

The determining may include determining a timing for outputting the text message based on the grade of the text message.

The determining may include determining the grade of the text message by comparing the extracted keyword with the user schedule.

The determining may include determining the grade of the text message by comparing a sender number of the text message with the address book.

The outputting may include outputting the text message based on the determined timing and a traveling state of the vehicle.

The method may further include storing at least one of the user schedule, the address book, the morpheme determination model, or the output policy.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram showing a control of a vehicle according to one embodiment of the present disclosure;

FIG. 2 is a view showing devices provided inside a vehicle (1) according to one embodiment of the present disclosure;

FIGS. 3, 4 and 5 are views illustrating an example of determining a grade of a text message;

FIG. 6 is a flowchart illustrating a method of controlling a vehicle according to one embodiment of the present disclosure; and

FIGS. 7 and 8 are views for specifically illustrating a method of controlling a vehicle of the present disclosure.

### DETAILED DESCRIPTION

Like reference numerals refer to like elements throughout the specification. This specification does not describe all the elements of the embodiments, and the general contents of the related art or duplicative contents in the embodiments will be omitted. The terms “unit,” “module,” “member,” and “block” used herein may be implemented by hardware or software. It is also possible that a plurality of units, modules, members, and blocks are implemented as one element, or one unit, module, member, or block includes a plurality of elements in accordance with the embodiments.

Throughout the specification, when an element is referred to as being “connected” to another element, it may be directly connected or indirectly connected to another element. The indirect connection includes a connection through a wireless communication network.

In addition, when some part “includes” some elements, unless explicitly described to the contrary, it means that other elements may be further included but not excluded.

The terms such as “first” or “second” may be used to distinguish one element from another, but the elements are not limited by the terms

Singular forms are intended to include plural forms unless the context clearly indicates otherwise.

Reference numerals of operations are used for convenience of description, and the reference numerals do not indicate the order of the operations. The operations may be performed in an order that is different from the described order unless a specific order is clearly described in context.

Hereinafter, an operation principle and embodiments of the present disclosure will be described with reference to the accompanying drawings.

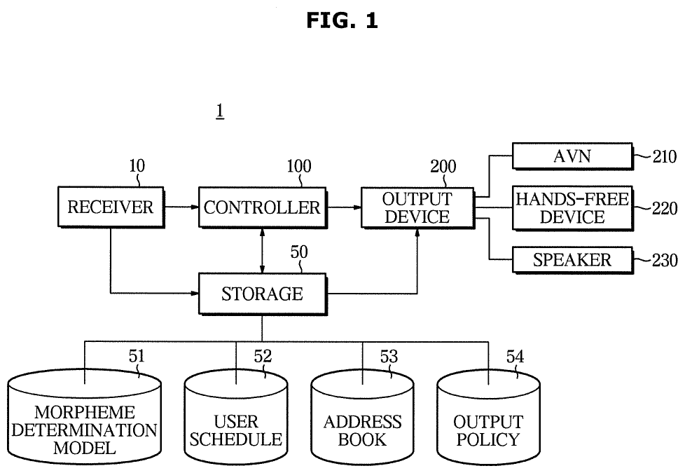

FIG. 1 is a block diagram showing a control of a vehicle according to one embodiment of the present disclosure.

With reference to FIG. 1, the vehicle 1 according to one embodiment includes: a receiver 10 configured to receive a text message from the outside; a controller 100 configured to analyze the received text message to determine a grade; a storage 50 configured to store the received text message and store a policy required configured to determine the grade of the text message; and an output device 200 configured to output the text message based on the determined grade.

Specifically, the receiver 10 may receive the text message from the outside of the vehicle 1.

The receiver 10 receives the text message from the outside via wired/wireless communication. For example, the receiver 10 receives the text message through various channels such as a user terminal, a base station, and another vehicle.

Herein, the user terminal refers to a computer or a portable terminal configured to transmit and receive a text message through a network.

The text message may include an alarm generated by a system, a call signal/text signal generated by a telephone base station, and data transmitted by a mobile network. In other words, hereinafter, the text message includes any signal including text information.

The receiver 10 may include at least one communication device which may be a hardware device implemented with various electronic circuits to transmit and receive signals via wireless connections and configured to enable communication with an external device, such as at least one of a short range communication module, a wired communication module, and a wireless communication module.

The short range communication module may include various short range communication modules configured to transmit and receive signals using a wireless communication network in a short distance, such as a Bluetooth module, an infrared communication module, a radio frequency identification (RFID) communication module, a wireless local access network (WLAN) communication module, an NFC communication module, and a ZigBee communication module.

The wired communication module may include not only various wired communication modules such as a controller area network (CAN) communication module, a local area network (LAN) module, a wide area network (WAN) module, and a value added network (VAN) communication module, but also various cable communication modules such as a Universal Serial Bus (USB), a high definition multimedia interface (HDMI), a digital visual interface (DVI), a recommended standard 232 (RS-232), a power line communication, and a plain old telephone service (POTS).

The wireless communication module may include wireless communication modules configured to support various wireless communication modes such as a global system for mobile communication (GSM), a code division multiple access (CDMA), a wideband code division multiple access (WCDMA), a universal mobile telecommunications system (UMTS), a time division multiple access (TDMA), a long term evolution (LTE) in addition to a WiFi module and a wireless broadband (WiBro) module.

The storage 50 stores the text message transmitted from the receiver 10, or stores the text message until an output timing of the text message based on the determined grade. Further, the storage 50 stores at least one of a user schedule, an address book, a morpheme analysis determination model, and an output policy which are necessary for the controller 100 to determine the grade of the text message.

Specifically, the storage 50 may be classified into a morpheme analysis determination model database (DB) 51 configured to segment a text included in the text message to extract a keyword of the text message, a user schedule DB 52 configured to store the user's schedule by date, an address book DB 53 configured to store information about a source from which a text message is received, and an output policy DB 54 configured to store an output policy based on the determined grade. The controller 100 determines information necessary for determining the grade and the output of the text message, with reference to the above-described various DBs. The various data used for determining the grade of the text message and determining the output will be described below with reference to the following drawings.

Meanwhile, the above-described various DBs are classified to describe the embodiments according to one embodiment, and the data may not be stored according to the above classification. In other words, the storage 50 may include at least one of a non-volatile memory device such as a cache, a read only memory (ROM), a programmable ROM (PROM), an erasable programmable ROM (EPROM), and an electrically erasable programmable ROM (EEPROM), a volatile memory device such as a random access memory (RAM), or a storage medium such as a hard disk drive (HDD) and a CD-ROM. The storage 50 may be a memory implemented as a chip separate from a processor, or may be implemented as a single chip integrated with the processor.

The controller 100 refers to a processor (e.g., CPU, etc.) configured to entirely control the disclosed vehicle 1. The controller 100 may control other components of the vehicle 1 including the output device 200 configured to output a notification about the text message and the reception of the text message.

The controller 100 extracts a keyword included in the text message transmitted from the receiver 10, compares the extracted keyword to the user schedule and the address book, and then determines a grade of the text message. In other words, the controller 100 determines the grade of the text message depending on urgency of the text message.

The controller 100 determines a timing for outputting the text message based on the determined grade, and selects a device among various devices included in the output device 200 to output the text message.

Specifically, a device configured to output the text message and an output timing are classified and stored in the output policy DB 54 according to the grade of the text message. The controller 100 collects information from various sensors provided in the vehicle 1 and determines a current traveling state of the vehicle 1 based on the collected information. The controller 100 may select an output device according to the traveling state of the vehicle 1 and the grade of the text message, and then determine the output device and the output timing for the text message.

Meanwhile, the controller 100 may be implemented through a memory (not shown) configured to store data with respect to an algorithm configured to control operations of the components in the vehicle 1 or a program reproducing the algorithm, and a processor (not shown) configured to perform the above-described operations by using the data stored in the memory. Herein, the memory and the processor may be implemented as separate chips. Alternatively, the memory and the processor may be implemented as a single chip integrated with each other.

The output device 200 outputs the text message according to the above-described output device and output timing which are determined by the controller 100. The output device 200 includes various devices provided in the vehicle 1. For example, the output device may be at least one of an AVN 210, a hands-free device 220, and a speaker 230.

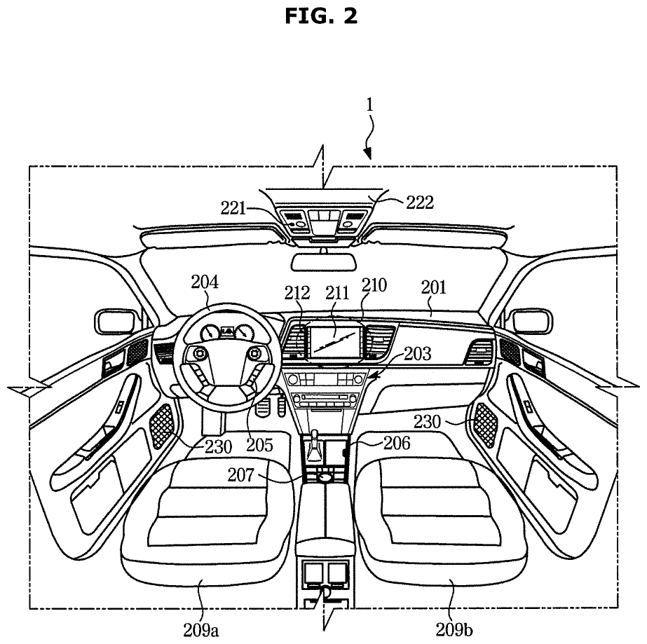

The AVN 210 refers to a device capable of integrally performing audio, video, and navigation functions. According to one embodiment, the AVN 210 may display the content of the text message in a text format via a display 211 (see FIG. 2).

The hands-free device 220 refers to a device configured to support a call function instead of a user terminal by amplifying a voice uttered by the user. According to an embodiment, when a type of the received text message is a phone call, the hands-free device 220 may output the voice of a caller into a sound.

The speaker 230 refers to a device configured to reproduce a sound output from the output device 200. According to an embodiment, the speaker 230 may read texts of the text message by using a voice or output a sound effect corresponding to a notification of the reception.

The output device 200 includes various apparatuses and devices configured to output the text message in addition to the above-described device, and it is enough that the controller 100 selects and controls a single or a plurality of devices and outputs the text message. When the text message is determined to be urgent, the output device 200 may use all of the above-described devices to output the text message. However, when the controller 100 determines that the text message is an advertisement, the output device 200 may output a simple sound effect through the speaker 230.

Meanwhile, the disclosed vehicle 1 may include various components in addition to the above-described components, and at least one element may be added or deleted in response to the performance of the components. Further, relative positions of the components may be changed corresponding to a performance or a structure of the system. Each component shown in FIG. 1 refers to software and/or hardware such as a field programmable gate array (FPGA) and an application specific integrated circuit (ASIC).

FIG. 2 is a view showing devices provided inside the vehicle 1 according to one embodiment of the present disclosure.

With reference to FIG. 2, a center fascia 203, which is located at a central area of a dashboard 201 inside the vehicle 1, may be provided therein with a display 211 including an audio function, a video function, and a navigation function or a dialing function to display a screen necessary for controlling the vehicle 1, and an input button 212 configured to receive a control instruction from the user.

Further, an input button 205 may also be provided on a steering wheel 204 for user's operational convenience, and a jog shuttle 207 serving as an input button may be provided in a center console area 206 between a driver seat 209a and a passenger seat 209b.

A module including the display 211, the input button 212, and the processor configured to entirely control various functions may be referred to the above-described AVN 210, or may also be referred to as a head unit.

The display 211 may be implemented as one of various display devices such as a liquid crystal display (LCD), a light-emitting diode (LED), a plasma display panel (PDP), an organic light-emitting diode (OLED), and a cathode ray tube (CRT).

The input button 212, as shown in FIG. 2, may be a hard key type in an area adjacent to the display 211, or the display 211 may be implemented as a touch screen type. In the case of touch screen type, the display 211 may perform the function of the input button 212 as well.

The vehicle 1 may receive the voice of the user for phone call. To this end, the vehicle 1 may include a microphone 221 configured to receive a sound, converting the sound into an electrical signal, and outputting the electrical signal, and the microphone 221 may transmit the electrical signal to the hands-free device 220.

According to one embodiment, as shown in FIG. 2, the microphone 221 may be provided in a head lining 222 for an effective voice input, but it is not limited thereto. The microphone 221 may also be provided on the dashboard 201 or the steering wheel 204. Further, there is no limit to the location for inputting the voice of the user.

The vehicle 1 may be provided therein with the speaker 230 configured to output the text message into a text-to-speech (TTS) format or outputting a sound effect configured to notify reception of the text message. Further, the speaker 230 may output a voice configured to guide navigation routes, an audio or voice included in an audio/video content, a voice configured to provide information or a service desired by the user, and a system utterance generated as a response to a user utterance.

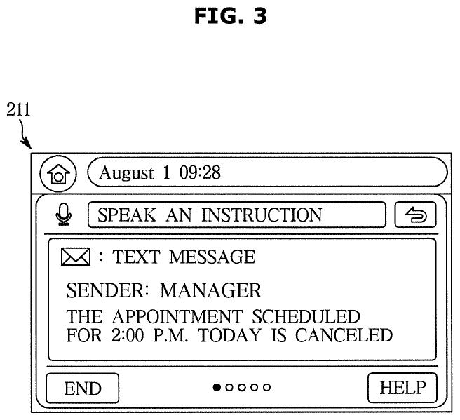

FIGS. 3 to 5 are views illustrating an example of determining a grade of a text message.

First, with reference to FIG. 3, the controller 100 may receive a text message that “the appointment scheduled for 2:00 P.M. today is canceled” from the receiver 10. The controller 100 may extract “today,” “2:00 P.M.,” “appointment,” and “cancel” as main keywords after analyzing the content of the received text message based on the morpheme analysis determination model.

The controller 100 compares the user schedule stored in the storage 50 based on a received time (August 1) among elements included in the text message. When a “meeting at 2:00 P.M.” is included on August 1 of the user schedule, the controller 100 may determine that the appointment included in the content of the currently received text message matches the meeting at 2:00 P.M.

The controller 100 may compare sender information with the address book among elements included in the text message to extract the sender information called “Manager,” and may determine the match with the acquaintance of the user. Through the series of determination processes, the controller 100 may determine the grade of the text message as urgent.

Meanwhile, the controller 100 may display and output the text message having a grade determined as urgent on the display 211. Further, the controller 100 may also output the text message determined as urgent as shown in FIG. 3 and deliver the text message to the user even when the vehicle 1 is traveling.

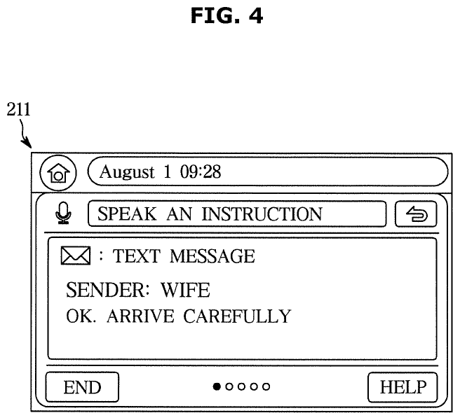

With reference to FIG. 4, the controller 100 may receive the text message “Arrive carefully” from the receiver 10. The controller 100 may extract keywords such as “arrive” and “carefully” after analyzing the content of the received text message based on the morpheme analysis model. Unlike FIG. 3, the controller 100 may determine that the extracted keywords are the keywords having a low urgency based on the morpheme analysis determination model stored in the storage 50.

The controller 100 may compare the sender information with the address book among elements included in the text message to extract sender information called “wife,” and determine that the sender information matches the acquaintance of the user.

The controller 100 may determine the grade of the currently received text message as normal by matching the extracted keywords and the acquaintance of the user.

The controller 100 may display and output the text message having the grade determined as normal on the display 211. However, unlike FIG. 3, the controller 100 may not display the text message determined as a normal grade on the display 211 while traveling, and may transfer the text message to the user after the vehicle 1 stops.

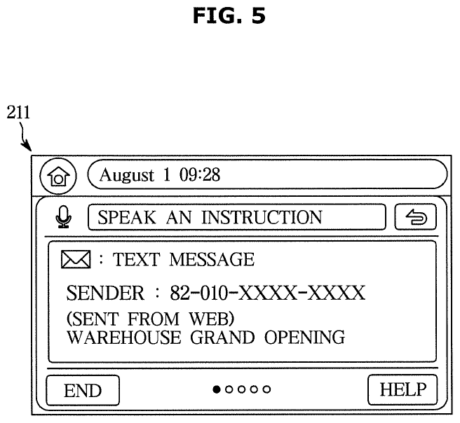

With reference to FIG. 5, the controller 100 may receive the text message “(sent from web) Warehouse grand opening” from the receiver 10. The controller 100 may extract “web,” “sent from,” “warehouse” and “grand opening” as main keywords after analyzing the content of the received text message based on the morpheme analysis model.

When the extracted keywords include “warehouse” and “grand opening” based on the morpheme analysis model, the controller 100 may determine the text message as an advertisement. Further, the controller 100, among elements included in the text message, may compare the sender information with the address book, and confirm that the address of the received text message is not included in the address book.

The controller 100 may determine the received text message as an advertisement grade through comparing the address book and a result of the matching of the extracted keywords.

The controller 100 may display and output the text message having the grade determined as an advertisement on the display 211. However, according to the user preset, the controller 100 may not output the text message of the advertisement grade on the display 211, or may output only a simple sound effect to the speaker 230 after the vehicle 1 stops.

The embodiments of FIGS. 3 to 5 are merely examples of an operation performed by the disclosed vehicle 1, and various modifications are applicable. Particularly, even when the extracted keywords include “warehouse” and “grand opening,” the text message may not necessarily be classified as the advertisement grade. The classification may be changed variously according to the user preset and the morpheme analysis model.

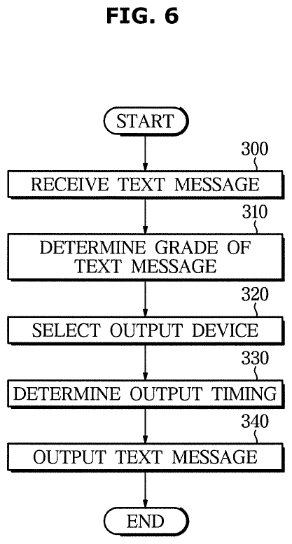

FIG. 6 is a flowchart illustrating a method of controlling the vehicle according to one embodiment of the present disclosure.

With reference to FIG. 6, the vehicle 1 receives a text message (300).

The vehicle 1 may receive the text message through various wired and wireless communication such as a user terminal, a nearby vehicle, and a base station. The text message includes sender information and content as described above, and may include any kind of various message configured to determine a grade thereof through the text.

The vehicle 1 determines the grade of the received text message (310).

Specifically, the vehicle 1 analyzes a morpheme of the text included in the received text message and extracts keywords. The extracted keywords are analyzed based on the morpheme analysis determination model. For example, when a keyword classified as an urgency grade is included in the text message, the text message may be determined as an urgency grade.

However, the vehicle 1 may not necessarily determine the grade only by the keyword, but may also determine the grade by comparing the sender information of the text message with the address book of the user. Further, even when the keyword includes only keywords that are not classified as urgent classes, the vehicle 1 may determine the text message as the urgency grade after comparing the extracted keywords with the user schedule.

When the grade is determined, the vehicle 1 selects a device configured to output the text message (320).

The vehicle 1 may transfer the reception of the text message and the content of the text message to the user through various devices.

For example, the vehicle 1 may output the text message by selectively using the AVN 210, the hands-free device 220, or the speaker 230. As another example, the vehicle 1 may output the text message by simultaneously using the AVN 210, the hands-free device 220, and the speaker 230.

The selection of the output device is determined based on schedules and address books of the occupants, the relationship between the occupants, and the vehicle 1 may select the device by the output policy DB 54 provided in the storage 50.

For example, the output policy DB 54 may be stored such that the text message determined as the urgency grade is visually displayed on the display 211, and the content of the text message is simultaneously output via the speaker 230 by using the TTS. The vehicle 1 may select the AVN 210 and the speaker 230 as an output device configured to output the content of the text message determined as the urgency grade to correspond to the output policy.

As another example, when the text message is received from a phone number registered in a plurality of address books of the occupants, the vehicle 1 may display the text message via the AVN 210 and simultaneously output the content of the message by using the TTS.

As still another example, when the text message is received from a phone number registered only in address books of a part of the occupants or an address book of the driver, the vehicle 1 may output the text message via the hands-free device 220, and simultaneously transfer the text message to a personal user terminal or the like of the occupant.

When receiving the text message from a phone number which is not stored in the address book, the vehicle 1 may output the text message via the hands-free device 220 or the TTS.

Meanwhile, the above-described embodiment may be preset by the user, and may be changed by the user. In other words, the vehicle 1 selects the output device based on the output policy 54 stored on the basis of at least one of the schedules of the occupants, the address book, the grade of the text message, and the relationship between the occupants.

When the output device is selected, the vehicle 1 may determine a timing for outputting the text message (330).

The conventional general vehicle 1, when the text message is received, collectively outputs the reception of the text message regardless of the situation. The disclosed vehicle 1 may delay an output of the text message having a grade other than the urgency grade, when the user is currently driving.

Specifically, when the vehicle 1 is traveling, the text message determined as a normal or advertisement grade is temporarily stored in the storage 50, and the text message is not output until the vehicle 1 stops or the user gets off. When the vehicle stops or the user gets off due to instruction from various sensors, inputters 205 or the like provided in the vehicle 1, the vehicle 1 may output the text message, for which the output is pending, via the selected output device.

The vehicle 1 determines the timing for outputting the text message having the determined grade by integrating the output policy and situation information collected in the vehicle 1.

The vehicle 1 outputs the received text message through the selected output device at the determined output timing (340).

Meanwhile, the disclosed vehicle 1 does not necessarily output the received text message. For example, the text message classified as the advertisement grade may not be output based on the output policy, and may be deleted when a predetermined time has elapsed after being stored in the storage 50 for a preset time.

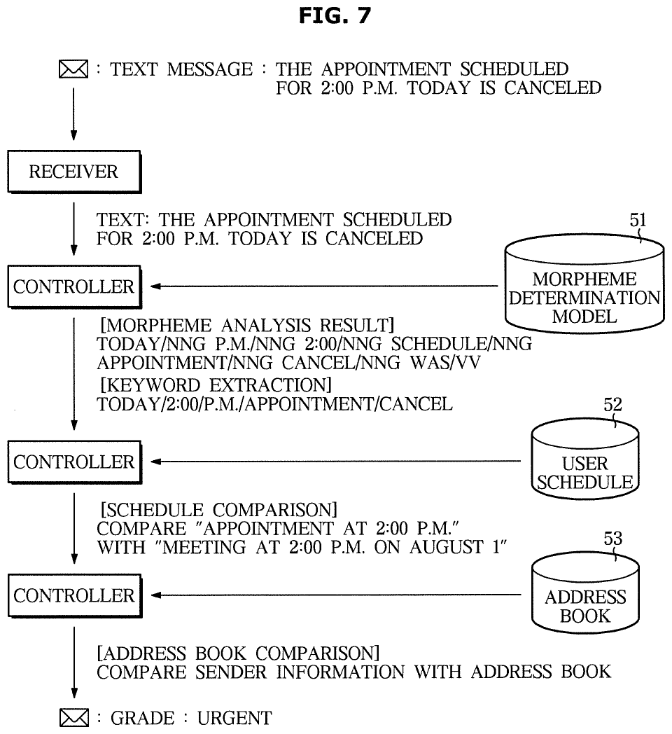

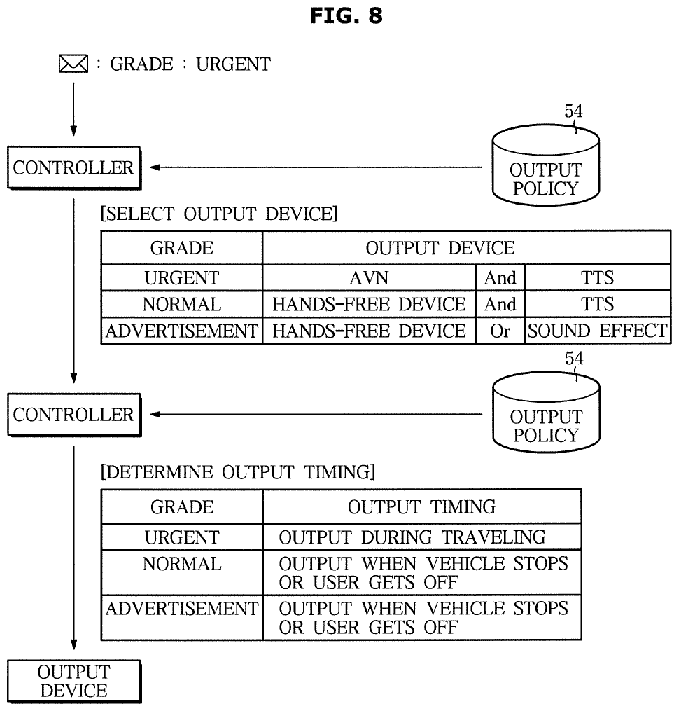

FIGS. 7 to 8 are views specifically illustrating a method of controlling a vehicle of the present disclosure.

With reference to FIG. 7, the text message similar to the embodiment described in FIG. 3 may be received by the receiver 10. The receiver 10 transmits texts included in the received text message to the controller 100, and the controller 100 analyzes the received text based on the morpheme analysis determination model.

Herein, the morpheme refers to a smallest unit having a meaning and represents a smallest semantic element that can no longer be segmented. The transferred character string is segmented into a morpheme string.

According to the embodiment as shown FIG. 7, the text may be analyzed as today/NNG, pm/NNG, 2:00 P.M./NNG, scheduled/NNG, appointment/NNG, cancel/NNG, and was/VV. The controller 100 may extract the today/NNG, 2:00 P.M./NNG, appointment/NNG, and cancel/NNG, which are classified in the morpheme analysis determination model, as keywords.

The controller 100 compares the today/NNG extracted as the keyword with the schedule of the user. For example, the controller 100 checks a user schedule for the current day included in the user schedule DB 52, and searches for the schedule of “Meeting at 2:00 P.M. on August 1.” The controller 100 may compare today/NNG and 2:00 P.M./NNG among the extracted keywords with “2:00 P.M. on August 1” in the user schedule, and then determine that the content of the received text message match the schedule of the user.

The controller 100 may compare sender information of the received text message with information stored in the address book DB 53, and confirm that the sender of the current text message is the acquaintance of the user.

The controller 100 may determine the grade of the text message as urgent by integrating the extracted keywords, the comparison of the user schedule, and the sender of the text message included in the address book.

With reference to FIG. 8, the controller 100 determines a device configured to output the text message having a grade determined as urgent. The controller 100 determines a device configured to output the text message according to the grade-specific output device included in the output policy DB 54.

According to an embodiment, the output policy may be set to output the text message having the urgency grade by using the AVN 210 and the TTS, may be set to output the text message having the normal grade by using the hands-free device 220 and the TTS, and may be set to output the text message having the advertisement grade by using the hands-free device 220 or the sound effect.

With reference to the output policy, the controller 100 may visually display the text message determined as urgent through the AVN 210, or output the text message by using the TTS via the speaker 230.

Unlike FIG. 8, when the text message is determined as the advertisement grade, the controller 100 determines whether the user is currently operating the hands-free device 220. When the hands-free device 220 is ON, the controller 100 may select the hands-free device 220 as an output device. When the hands-free device 220 is OFF, the controller 100 may select the speaker 230 as the output device to output the sound effect.

Referring back to FIG. 8, after selecting the output device, the controller 100 determines a timing for outputting the text message determined as the urgency grade.

According to an embodiment, the output policy may be set to output the text message determined as urgent even when the vehicle 1 is traveling, and may be set to output the text message determined as the normal grade or the advertisement grade when the vehicle 1 stops or the user gets off.

The controller 100 determines the output timing based on the current traveling state of the vehicle 1 and the grade of the text message. As shown in FIG. 8, the text message determined as the urgency grade is determined to be output even when the vehicle 1 is traveling.

The controller 100 controls the output device 200 to output the text message through the selected device even when the vehicle 1 is traveling, and the output device 200 displays the content of the text message through the AVN 210 and simultaneously transfers the content of the text message to the user by using the TTS through the speaker 230.

Meanwhile, the vehicle 1 according to the embodiments is not required to select the timing for outputting the text message after selecting the output device, and the sequence may be changeable. Further, the output policy shown in FIG. 8 is merely an example, and the output device and the output timing may be variously changed according to the grade.

According to the vehicle 1 and the method of controlling the vehicle 1 disclosed herein, a grade required for a transfer to the user is classified by analyzing the received text message, such that a driver's attention can be prevented from being distracted, and privacy can be protected. Further, according to another aspect of the vehicle and the method of controlling the same, convenience and service quality can be improved by variably changing the grade of the text message according to the schedule and address book of the user.

Meanwhile, the disclosed embodiments may be implemented in the form of a recording medium for storing instructions executable by a computer. The instructions may be stored in the form of program code and may generate a program module when executed by a processor to perform the operations of the disclosed embodiments. The recording medium may be implemented as a computer-readable recording medium.

The computer-readable recording medium may include any kind of recording media where instructions which can be decoded by a computer are stored. For example, the recording media may include a ROM, a RAM, a magnetic tape, a magnetic disk, a flash memory, an optical data storage device, and the like.

As is apparent from the above description, the vehicle and the method of controlling the same of the above-mentioned technical solution, a grade required for a transfer to the user is classified by analyzing the received text message, such that the driver's attention can be prevented from being distracted, and privacy can be protected.

Further, according to the vehicle and the method of controlling the same of another aspect, convenience and service quality can be improved by variably changing the grade of the text message according to the schedule and address book of the user.

1. A vehicle comprising:
a receiver configured to receive a text message from an outside;
an output device configured to output a notification about the text message and a reception of the text message; and
a controller configured to determine a grade of the text message transferred from the receiver,
wherein the controller extracts a keyword included in the text message based on a morpheme analysis determination model and determines the grade of the text message based on the extracted keyword, and
wherein the controller selects a device included in the output device based on at least one of a user schedule, an address book, a relationship with an occupant, or the determined grade of the text message which are stored in advance.

2. (canceled)

3. The vehicle of claim 1, wherein the controller determines the grade of the text message by comparing the extracted keyword with a user schedule.

4. The vehicle of claim 1, wherein the controller determines the grade of the text message by comparing a calling number of the text message with an address book.

5. (canceled)

6. The vehicle of claim 1, wherein the device includes at least one of an audio video navigation (AVN), a hands-free device, or a speaker.

7. The vehicle of claim 1, wherein the controller determines a timing for outputting the text message based on the determined grade of the text message, and controls the output device based on the determined timing.

8. The vehicle of claim 7, wherein the output device outputs the text message based on the determined timing and a traveling state of the vehicle.

9. The vehicle of claim 1, further comprising: a storage configured to store at least one of a user schedule, an address book, a morpheme determination model, or an output policy.

10. A method of controlling a vehicle, the method comprising:
receiving a text message from an outside;
determining a grade of the received text message; and
outputting a notification about the text message or a reception of the text message based on the determined grade of the text message,
wherein the determining a grade comprises:
extracting a keyword included in the text message based on a morpheme analysis determination model; and
determining the grade of the text message based on the extracted keyword, and
wherein the outputting of the notification comprises selecting an output device included in the vehicle based on at least one of a user schedule, an address book, a relationship with an occupant, or the determined grade of the text message which are stored in advance.

11. (canceled)

12. The method of claim 10, wherein the determining a grade further comprises determining the grade of the text message by comparing the extracted keyword with the user schedule.

13. The method of claim 10, wherein the determining a grade further comprises determining the grade of the text message by comparing a sender number of the text message with an address book.

14. (canceled)

15. The method of claim 10, wherein the output device includes at least one of an audio video navigation (AVN), a hands-free device, or a speaker which is provided in the vehicle.

16. The method of claim 10, wherein the determining a grade further comprises determining a timing for outputting the text message based on the grade of the text message.

17. The method of claim 16, wherein the determining a timing comprises outputting the text message based on the determined timing and a traveling state of the vehicle.

18. The method of claim 10, further comprising storing at least one of a user schedule, an address book, a morpheme determination model, or an output policy.
